(19) United States
(12) Patent Application Publication
(10) Pub. No.: US 2019/0160312 A1
(43) Pub. Date: May 30, 2019

(54) PORTABLE DEVICE TO REDUCE FIRE DAMAGE FROM A NEIGHBORHOOD FIRE

(71) Applicant: Richard C.K. Yen, Yorba Linda, CA (US)

(72) Inventor: Richard C.K. Yen, Yorba Linda, CA (US)

(21) Appl. No.: 16/202,266

(22) Filed: Nov. 28, 2018

Related U.S. Application Data
(60) Provisional application No. 62/591,731, filed on Nov. 28, 2017.
(60) Provisional application No. 62/729,576, filed on Sep. 11, 2018.

(51) Int. Cl. A62C 3/02; F16L 37/48

(52) U.S. Cl. CPC A62C 3/02; F16L 37/48

(57) ABSTRACT

The present technology essentially is a portable fire damage reducing system and method including a fluid system for storing or dispensing a fluid. The fluid system can include a head unit, a body unit and a tail unit. The head unit can include a first end connectable to a fluid source. The body unit can include a first end connectable to a second end of the head unit, and a second end. The body unit can be configured to store fluid or to deliver fluid. The tail unit can include a first end connectable to the second end of the body unit, and a second end having a configuration capable of being open to the atmosphere for dispensing the fluid from the body unit or connected to the first end of the head unit to form a closed looped system with the fluid stored in the body unit.

### CROSS-REFERENCE TO RELATED APPLICATION

This application claims the benefit of priority under 35 U.S.C. § 119(e) based upon co-pending U.S. provisional patent application Ser. No. 62/591,731 filed on Nov. 28, 2017, and U.S. provisional patent application Ser. No. 62/729,576 filed on Sep. 11, 2018. The entire disclosures of the prior provisional applications are incorporated herein by reference.

### BACKGROUND

### Technical Field

This present technology concerns a method and a device to reduce the chance of a neighborhood fire destroying a building and its content entirely.

### Background Description

A neighborhood fire is a fire that can burn down the whole neighborhood, i.e. it burns more than one house or building. It can start from a remote wild fire far away, or it can start from a fire from one's immediate neighbor's house. There is typically some time for the homeowners or business owners to pack up essential documents and cash before they leave the building for safer areas. However, some owners will stay at great personal risk to save the house or building or their contents.

At the present time, there are very few devices to help reduce the chance of the building being burn down completely. An owner leaving the building can only hope that the neighborhood fire will not reach his own home or business building; or that the firefighters can arrive to pour water onto the building before it completely burns down. An owner who chooses to stay can only turn on the faucet to water the lawn or spray water onto the roof or the walls in hope that the water will wet the material enough so that the house will not burn.

Typically, these methods are inefficient and ineffective. First, it requires a substantial amount of water to saturate the front yard or back yard, or lawn so that the trees and shrubs so as not to burn. Second, the water tends to drain into the soil before the fire arrives and is not there to put out the fire. Thirdly, any water sprayed onto the roof or a wall will simply run down by gravity into the soil and whatever remains on the surface will quickly be evaporated when or before the fire arrives.

Therefore, there is a dire need for better methods and devices to help homeowners and any interested parties including insurance companies to reduce the likelihood of any building burning down when there are still a few minutes left to do something helpful that is also reversible, economic, sensible and effective.

Therefore, a need exists for a new and novel portable fire damage reducing system and method that can be used for reducing the chance of a neighborhood fire destroying a building. In this regard, the present technology substantially fulfills this need. In this respect, the portable fire damage reducing system and method according to the present technology substantially departs from the conventional concepts and designs of the prior art, and in doing so provides an apparatus primarily developed for the purpose of reducing the chance of a neighborhood fire destroying a building.

### BRIEF SUMMARY OF THE PRESENT TECHNOLOGY

In view of the foregoing disadvantages inherent in the known types of home fire safety systems, the present technology provides a novel portable fire damage reducing system and method, and overcomes the above-mentioned disadvantages and drawbacks of the prior art. As such, the general purpose of the present technology, which will be described subsequently in greater detail, is to provide a new and novel portable fire damage reducing system and method and method which has all the advantages of the prior art mentioned heretofore and many novel features that result in a portable fire damage reducing system and method which is not anticipated, rendered obvious, suggested, or even implied by the prior art, either alone or in any combination thereof.

One aspect of the present technology can be a method can involve the use of a device, which is a lightweight, flexible tubular system that can be filled with water quickly from any faucet or water source inside or outside the house. The device can then be placed in strategic locations inside or outside the building, so that the water can leak out of the system to quench any fire or form gaseous water to moisturize the air so that the contents of a house will not burn. If a fire never reaches the house, the water can be emptied from the system with minimal water-damage to the house.

According to one aspect, the present technology can essentially include a fluid system for storing or dispensing a fluid. The fluid system can include a head unit, a body unit and a tail unit. The head unit can include a first head end connectable to a fluid source. The body unit can include a body first end connectable to a head second end of the head unit, and a body second end. The body unit can be configured to store fluid or to deliver fluid. The tail unit can include a tail first end connectable to the body second end of the body unit, and a tail second end having a configuration capable of being open to the atmosphere for dispensing the fluid from the body unit or connected to the head first end of the head unit to form a closed looped system with the fluid stored in the body unit.

According to another aspect, the present technology can include a portable device to reduce fire damage. The device can include a head unit attachable to a faucet, a body unit configured to store or deliver water from the faucet, and a tail unit configured to dispense water from the body unit.

According to yet another aspect, the present technology can essentially include a method of using a fluid system including the steps of connecting a head first end of a head unit to a water source, receiving fluid in a body unit from the head unit, and utilizing a tail unit to dispense the fluid from the body unit or store the fluid in the body unit by connecting a tail second end of the tail unit into the first end of the head unit when the head first end of the head unit is disconnected from the water source.

There has thus been outlined, rather broadly, features of the present technology in order that the detailed description thereof that follows may be better understood and in order that the present contribution to the art may be better appreciated.

In some embodiments, the head unit can include a head intermediate section having a conical configuration converging from the head first end toward the head second end of the head unit.

In some embodiments, the head first end of the head unit can include one or more flaps extending therefrom, one or more flap holes defined through the flaps, and multiple radially arranged slits defined through the head first end of the head unit.

In some embodiments, the head second end of the head unit can include one or more holes defined therethrough, the holes each being configured to engageably receive a protrusion extending from the body first end of the body unit.

Some embodiments, the tail unit can include a tail intermediate section having a conical configuration converging from the tail first end toward the tail second end of the tail unit.

In some embodiments, the tail first end of the tail unit can include one or more protrusions extending therefrom, and the body second end of said body unit can define one or more holes each configured to engageably receive at least one of the protrusions extending from the tail first end of the tail unit.

Some embodiments, the tail unit can include one or more second protrusions extending from the tail intermediate section, each of the second protrusions can be configured to be engageably received in one of the flap holes.

In some embodiments, the head unit can include a bulged section between the head first end and the head intermediate section, the bulged section can have a diameter larger than the head first end and the head intermediate section.

In some embodiments, the body unit can include a conduit extending between the body first end and the body second end of the body unit.

In some embodiments, the head unit can include a mouth associated with the head first end, an entrance section adjacent the mouth, a pouch section adjacent the entrance section, a pharynx adjacent the pouch section, and an esophagus section adjacent section adjacent the pharynx and associated with the head second end.

Some embodiments, the head unit can include a neck section extending from the pharynx and exteriorly concentric with the esophagus section.

Embodiments of the present technology can include a collar having a collar first end featuring a wedge extending outwardly and away from the collar first end. The wedge can include a catch surface, and the neck section can include a catch surface extending interiorly therefrom and configured to engage with the catch surface of the wedge when the collar first end is received into the neck section of the head unit.

In some embodiments, the collar can include a collar second end connectable to the body first end of the body unit.

In some embodiments, the entrance section has a diameter less than a diameter of the mouth, the pouch section has a diameter greater than the entrance section, the pharynx has a diameter less than the pouch section, and the esophagus section has a diameter less than the pharynx.

Some embodiments, the head unit can be configured to be attachable to a faucet so that a fluid output of the faucet is received in the head first end of the head unit.

In some embodiments, the head unit can include a strand extending from the head first end, the strand can include multiple enlarged sections each being configured to be engageable with a hole defined in the head unit.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is therefore an object of the present technology to provide a new and novel portable fire damage reducing system and method that has all of the advantages of the prior art xother and none of the disadvantages.

It is another object of the present technology to provide a new and novel portable fire damage reducing system that may be easily and efficiently manufactured and marketed.

An even further object of the present technology is to provide a new and novel portable fire damage reducing system that has a low cost of manufacture with regard to both materials and labor, and which accordingly is then susceptible of low prices of sale to the consuming public, thereby making such portable fire damage reducing system economically available to the buying public.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology.

### BRIEF DESCRIPTION OF THE DRAWINGS

The present technology will be better understood and objects other than those set forth above will become apparent when consideration is given to the following detailed description thereof. Such description makes reference to the annexed drawings wherein:

FIG. 1 is an overall perspective view of an embodiment of the portable fire damage reducing system and method constructed in accordance with the principles of the present technology, with the phantom lines depicting environmental structure and forming no part of the claimed present technology.

FIG. 2 is a perspective view of the head unit of the present technology.

FIG. 3 is a cross-sectional view of the head unit take along line 3-3 in FIG. 2.

FIG. 4 is a perspective view of the tail of the present technology.

FIG. 5 is a cross-sectional view of the tail take along line 5-5 in FIG. 4.

FIG. 6 is cross-sectional view of the tail unit received in the head unit to form a closed loop circuit the present technology.

FIG. 7 is perspective view of an alternative head unit of the present technology.

FIG. 8 is a perspective view of the head unit accepting a straight-out faucet design.

FIG. 9 is a perspective view of the head unit accepting a right-angled outward faucet design.

FIG. 10 is a perspective view of an alternative head unit of the present technology.

FIG. 11 is a perspective view of the collar engageable with the alternative head unit of FIG. 9 and the body unit.

FIG. 12 is a perspective view of an alternative tail of the present technology.

FIG. 13 is a perspective view of the head unit of the present technology including alternative flaps and the strand.

The same reference numerals refer to the same parts throughout the various figures.

### DETAILED DESCRIPTION OF THE PREFERRED EMBODIMENTS

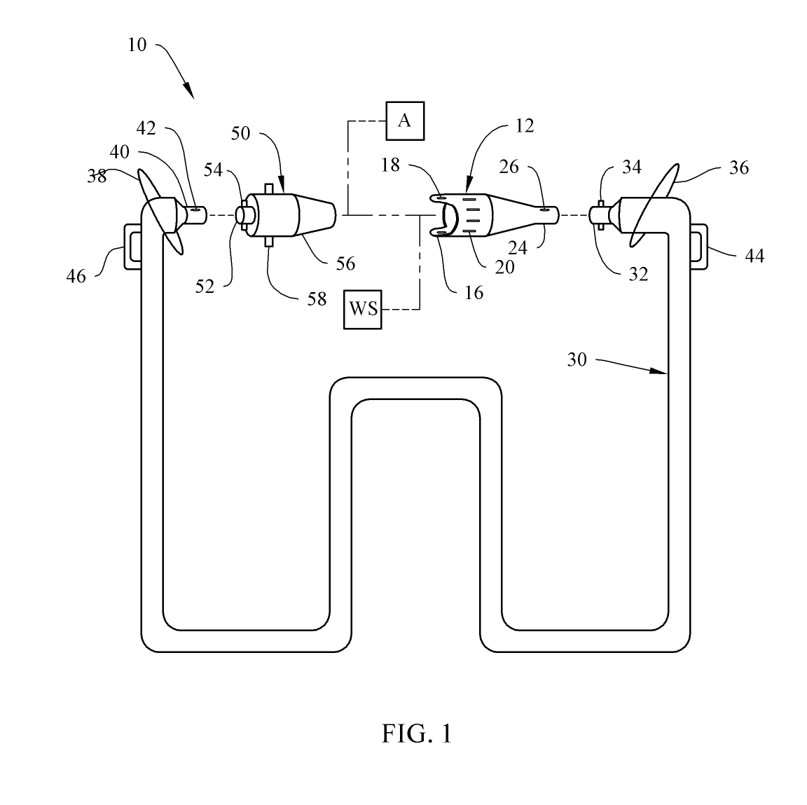

Referring now to the drawings, and particularly to FIGS. 1-13, an embodiment of the portable fire damage reducing system and method of the present technology is shown and generally designated by the reference numeral 10.

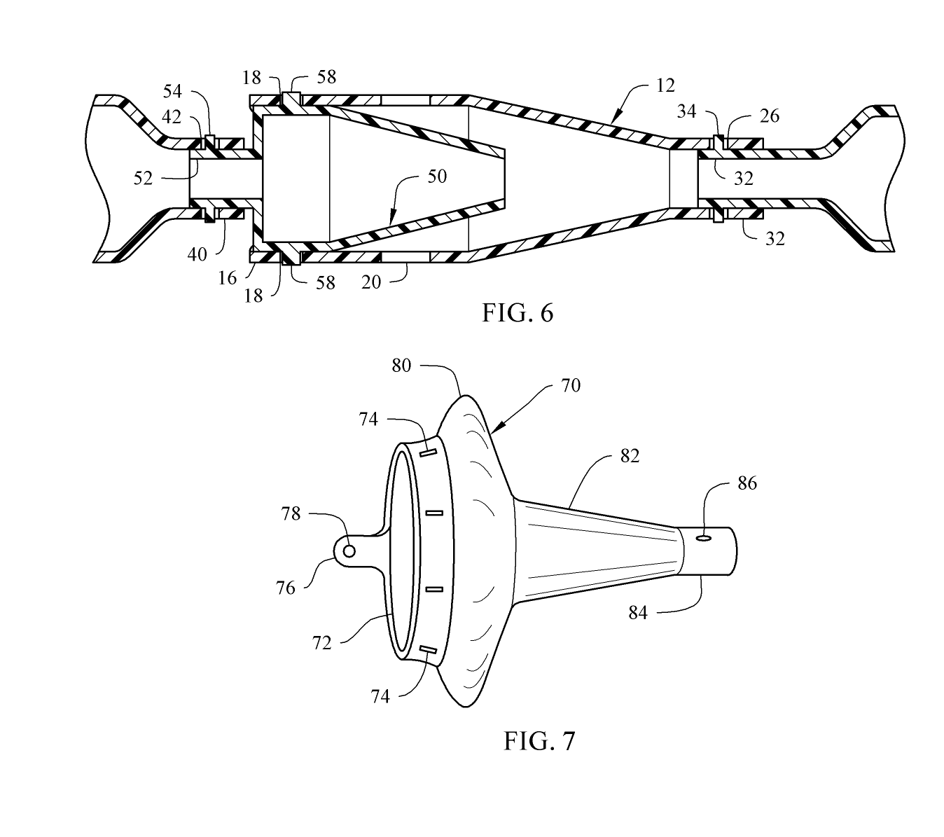

In FIG. 1, a new and novel portable fire damage reducing system and method 10 of the present technology for reducing the chance of a fire destroying a building, is illustrated and will be described. More particularly, the portable fire damage reducing system and method 10 can include a head unit 12 connectable to a water source WS or capable of receiving water, a body unit 30 configured to store water or to deliver water, and the tail unit 50 capable of being left open for water to slowly evaporate into the atmosphere/air A or configured to be inserted into an open end of the head unit 12 unit to form a closed (and circular) system, as best illustrated in FIGS. 1 and 6.

A neighborhood fire can burn down the “whole neighborhood.” More than one house will burn. The source of such a fire can come from a wild (or forest) fire from some distance. Alternatively, it can start from one's immediate neighbor's home. Sometimes the whole city is involved, or a large segment of a state, e.g. California.

Residence or owner of a house needs to make a quick decision. Usually it is based on how close the approaching fire is and how severe it is. When the fire is severe, the civil authorities will usually recommend evacuation, or even enforce evacuation. An owner leaving the home or building can only hope that the fire will end up not reaching his own home or business building; or that the firefighters can arrive to pour water onto the building before it completely burns down. An owner who chooses to stay can only turn on the faucet to water the lawn or shoot water onto the roof or the walls for a few minutes in hope that the water will wet the material enough so that the house or its contents will not burn. Usually that approach does not work.

Typically, these methods are inefficient and ineffective. First, to saturate the front yard or back yard, or lawn (so that the trees and shrubs there will not burn) will take a lot of water. Second, the water tends to drain into the soil before the fire arrives and is not there to put out the fire. Thirdly, any water sprayed onto the roof or a wall will simply run down by gravity into the soil and whatever water remains on the surface will quickly be evaporated when or before the fire arrives.

One startling observation after a fire is how some homes remain completely intact while its neighboring homes are completely burn down. There seems to be no “rhyme or reason” why that is so, particularly when the homes that burn down are made essentially of the equivalent material as the home that has suffered little damage.

Careful study of the burnt site will reveal some insights. There is a plenty of evidence to indicate that most houses burn from inside outward. Practically all the broken glass from broken windows lie outside the house, clear evidence that the pressure or heat inside the house is higher than outside, so that the glass fly toward the street.

The conventional concept of a neighborhood fire is that the fire spreads from somewhere in the neighborhood and it burns towards the house and therefore the house catches fire from “outside-inward.” Careful studies will show that while the flames of a fire are typically seen outside the house before the house burns down, the effects of a fire are more sinister. There are at least two major sources of how a fire can start within a house before the “outside” flames reach to the house. (1) Embers of a fire can travel miles ahead unit of a wild fire and enter the interior of a house via the open chimney. The embers then start burning the furniture or books near the chimney. Therefore, the fire really starts from within. (2) Radiation heat can be very substantial. Often, the air around a wild fire is so hot that the heat can penetrate the closed windows or closed glass doors to burn the wood and other combustible material inside the house, before the flame can reach the house. Unfortunately, most houses have curtains near the windows, which will burn easily; and nobody thinks of taking those curtains down first even when there is time. Obviously if a reflective material, such as a metal (e.g. aluminum) board can be placed next to the closed glass door, so that the heat from the advancing hot air can be reflected back to the outside, the temperature inside the house will be lower than otherwise. However, in a crisis where one needs to escape with one's life and dearest possessions, these are not practical solution to be deployed in order to save the house or its contents.

The present technology is both a method and a device. The method involves the use of a device, which can be quickly filled with water and placed in strategic locations, e.g. on the floor next to a glass door, or inside the fire place which has a chimney which nobody is sure how tightly it can be closed, so that the device can release water to douse the materials around it before they catch fire. The leakage of water from the device is design to happen when the temperature around the device is hot enough to cause the release of water, without the presence or help from the owner or any other helper.

The device itself comprises of a lightweight, flexible tubular system that can be filled with water quickly from any faucet or water source inside or outside the house. The device weighs about 22 pounds after it is filled with water and so it can be dragged or moved easily as the user sees fit. The device can be connected to any number of additional and similar devices so that the amount of water to douse the fire can be as much as the owner of the house has prepared for the size of the house. After all the water-filled devices have been placed in the strategic location (or even before that) the owner can leave the building.

Alternatively, if the owner decides to stay and use the device actively, the alternative method is this: the device can also be straightened into the form of a fire-hose so that water can be sprayed from the water source (such as a faucet) to a fire directly, even though the fire is some distance away from the water source. One can of course use a garden hose to do this. However, the threads on a garden hose can only fit the water source designed for a garden hose; it is impossible to use the water sources inside the house e.g. a faucet or a showerhead. To deliver the water from the water source to the fire, the owner can use a bucket if the device of this present technology is not available. However, a bucket of water is heavy and running from one location (the water source) to the other location (the fire) is tiring, takes time and is not very effective. Therefore, the device of this present technology can be used in both ways: in a passive manner, i.e. place in a location where leakage of water caused by the heat can quench the fire; or it can be used in a positive manner, i.e. delivering water like a fire-hose from any faucet or pipe to the fire directly.

The method and device also have the advantage that if the neighborhood fire never reaches the house, the water can be emptied from the device with minimal water-damage to the house, the floor, the carpet and the furniture.

It has been discovered in accordance with this present technology that a flexible connector, which in essence is funnel-shaped, can allow the device to be attached securely to almost all household faucets or a water source; the said funnel-shaped connector being at the entry (proximal) end of the device for water to fill the device.

It has been further discovered in accordance with this present technology that a collapsible (and expandable) tubular system (or bag) made of flexible, flame-retardant material can be constructed so that it can be easily stored with minimal space requirement when empty, but it can be quickly filled with water if needed; the capacity of one such tubular system can range from 10 to 22 pounds of fluid.

It has been further discovered in accordance with this present technology that water from a household faucet can fill the tubular system in one to two minutes; but if there is no time to completely fill the device, a partially filled device can still be useful. The most common fluid to be used to fill the device is water, but it is anticipated that any additive to water or other fluids that can retard flames can be filled into the device.

It has been further discovered in accordance with this present technology that the tubular portion of the device can be coiled into any shape after being filled with water, including the coil taking the shape of a panel which can easily be placed inside a fireplace below a chimney; or the water-filled coil can be stretch out in a more or less straight line to be placed along a window so that any leaked or spilled water will have maximum effect in cooling the area where the water-filled device is placed.

It has been further discovered in accordance with this present technology that device can be uncoiled so that the tubular structure can be used like a fire-hose.

It has been further discovered in accordance with this present technology that the other (distal) end of the device can be fitted with a male counterpart to fit inside the funnel-shape at the proximal end of the device so that when the two are joint together, the entire tubular system, with or without water, is a continuous and closed system.

It has been further discovered in accordance with this present technology that in some situations, it would be advantageous for the owner to stretch out the tubular system so that it is in the shape of a thick rope (or garden hose) rather than coiled as a flat carpet (or panel). Therefore, the device can be equipped with additional plugging devices, e.g. a cap for the distal end and a clamp for the proximal end, so that the water will not leak from the system until the fire or hot air causes a leak. Alternatively, two clamps can be used, one on the proximal end and one on the distal end, to prevent water from flowing out before the fire or hot air arrives.

It has been further discovered in accordance with this present technology that when the temperature of the environment is hot enough, the water will also heat up and generate enough pressure to cause the system to leak water.

It has been further discovered in accordance with this present technology that leakage of 22 pound (10 liters) of water will then converted into steam. This process of vaporization can easily absorb a large amount of energy from the air: the equivalence of the heat of vaporization of this weight of water, which will result in less heat being absorbed by the furniture towards their combustion. The heat of vaporization of water is 2257 Joule per gram of water.

It has been further discovered in accordance with this present technology that the provisional of a pan (or a box) which is optional, would allow the entire coiled tubular bag to sit within the pan, so that the bag can be easily dragged from the water source to where it is most needed, and that if the fire does not reach the house, the bag can be moved to a place e.g. a sink (or outside) where the water can be emptied without substantially wetting the floor or carpet. In addition, should there be a spillage of water from the bag, the water will be held within the pan, thus serving the purpose of minimizing any “water-damage” to the floor or carpet.

The following discussion regards facts about a neighborhood fire and why the present technology is effective in reducing the likelihood of a building or its content from burning during such a fire.

It is well known that the relative humidity (RH) of the air surrounding a combustible material has a major effect on whether the material will catch fire. RH is the ratio of moisture in the air compared to the amount of moisture that would saturate the air, and it is expressed as a percentage. According to sultanaeducation.org, when the RH is greater than 65%, the “moist air” inhibits combustion. In general, a RH of 50% or less is needed for “fire-making”. When the RH reaches at 20% or below, fuels can become “explosive.” Indeed, low RH is the major contributing factor in many major fires, in additional to, and probably more important to the spread of a fire, than the “high temperature” in the air before the fire starts.

The temperature of a bonfire can reach to 1,100° C. (or 2,012° F.). At this temperature, its major effect on the surrounding air is that the fire will desiccate a large volume of air. Anyone who has gone camping would remember how dry it is when sitting near the campfire. The inventor has personally witnessed during a firestorm how the approaching hot air could dry up the green leaves of a tree next to a riverbed. The author was evacuating from the neighbor fire that day and was surprised to see that the leaves of a tree about twenty yards away would “auto-combust” without any flames seen anywhere near the tree. In other words, the dry air generated by the wild fire situated some distance away from the road was able to lower the RH around the tree so severely that the leaves would burn without having to wait for the flame itself to arrive. The simultaneous and instantaneous combustion of all the leaves was complete within seconds—this author felt like he was watching a special effect in a movie, except the experience was hot, dry, strong and real. Within seconds, the combustion left only the darkened trunk of the tree still standing at the roadside. However, the heat generated by the burning of the leaves from the first tree would generate another pulse of hot approaching air, which caused a second tree closer to the author to burn completely within the next few seconds. The author was lucky to be able to escape.

A search on the “combustion temperature” of various materials would show that wood and paper would ignite spontaneously at about 190° C. to 260° C., and 233° C., respectively. Plastic material, such as polyethylene, polystyrene, and polypropylene would burn at higher temperatures, at 349° C., 488-496° C., and 570° C., respectively. The melting temperatures for polystyrene, polyethylene, and polypropylene are 100-120° C., 122-137° C., and 158-168° C., respectively. However, these plastic materials to be considered for use in this present technology will be in contact with water when subject to high temperature; so their melting temperature as used in this present technology may be different from the same stand-alone material. Therefore, plastic material such as these would be able to maintain their intactness and shape unless additional factors are at play, including the pressure generated from the water inside the tubular structure as the temperature rises to about 100° C. or above. At these high temperatures, the RH of the room is not meaningful because water in the room would have completely evaluated into the gaseous state, at any temperature above 100° C.

The material to be used to form the various parts of the present technology can be chosen from material that is elastic or stretchable, such as natural rubber, or synthetic rubber such as synthetic polyisoprene, styrene-butadiene rubber, nitrile rubber, polychloprene, silicone. Silicone can also be added additives that will render the silicone non-combustible, or flame-retardant, e.g. UL94V-0 certified silicone. Neoprene is a very stretchable material.

The volume of water to be filled into the tubular structure in this present technology should be about 10 liters. This volume should increase the relative humidity (RH) of a 20 feet×20 feet×10 feet room to such a high RH that the material inside the room would not ignite. As long as the material inside the house does not burn, the fire on the outside will consume all the trees and combustible material outside, after which the temperature outside will start to cool down.

The calculations of the RH produced from 10 liters of water are as follows: Table 1 below is taken from hyperphysics_phy-astr.gsu.edu/hbase/kinetic/watvap.html#cl.

TABLE 1
Saturated Vapor Pressure, Density for Water

| | | Saturated Vapor | Saturated Vapor |
|---|---|---|---|
| Temp | Temp | Pressure | Density |
| (° C.) | (° F.) | (mmHg) | (gm/m³) |
| −10 | 14 | 2.15 | 2.36 |
| 0 | 32 | 4.58 | 4.85 |
| 5 | 41 | 6.54 | 6.8 |
| 10 | 50 | 9.21 | 9.4 |
| 11 | 51.8 | 9.84 | 10.01 |
| 12 | 53.6 | 10.52 | 10.66 |
| 13 | 55.4 | 11.23 | 11.35 |
| 14 | 57.2 | 11.99 | 12.07 |
| 15 | 59 | 12.79 | 12.83 |
| 20 | 68 | 17.54 | 17.3 |
| 25 | 77 | 23.76 | 23 |
| 30 | 86 | 31.8 | 30.4 |
| 37 | 98.6 | 47.07 | 44 |
| 40 | 104 | 55.3 | 51.1 |
| 60 | 140 | 149.4 | 130.5 |
| 80 | 176 | 355.1 | 293.8 |
| 95 | 203 | 634 | 505 |
| 96 | 205 | 658 | 523 |
| 97 | 207 | 682 | 541 |
| 98 | 208 | 707 | 560 |
| 99 | 210 | 733 | 579 |
| 100 | 212 | 760 | 598 |
| 101 | 214 | 788 | 618 |
| 110 | 230 | 1,074.6 | . . . |
| 120 | 248 | 1,489 | . . . |
| 200 | 392 | 11,659 | 7,840 |

This can lead to the question, what is the mass of water (water content in vapor) in this room at 30° C., 50% RH?

The answer is: 30.4 gram of water per cubit meter×50%, or 15.2 gram of water per cubit meter. The room is 20 feet×20 feet×10 feet, which is 4,000 cubit feet, or 113.3 cubit meters. Therefore the water content in the room before release of the water in the present technology is: 15.2 gram per cubit meter×113.3 cubit meter, or 1,722 grams of water.

This can lead to the question, what will be the new RH if the room temperature is raised (by radiation heat from the outside) from 30° C. to 60° C.? (60° C. is equal to 140° F.; nobody will be able to stay inside this room at this temperature.)

The answer is: releasing 10,000 gram of water inside the room will raise the total water content (in vapor form) to 10,000 plus 1,722 gram, or 11,722 gram of water.

From Table 1 above, the weight of water needed to provide 100% RH is 130.5 gram per cu meter. Therefore, the total weight of water needed is 130.5×113.3 or 14,786 gram.

The RH provided by 11,722 gram of water at 60° C. will result in effect a RH of 11,722/14,786, or 79% RH. At this high RH, most furniture and combustible material will not burn. The fire on the outside will burn up whatever trees or bushes outside and will pass; leaving the content of this “well-moisturized” room not burned.

Another consideration is the effect of the evaporation of 10 liters of water: how much does that process lower the temperature of the room.

The heat of vaporization of water is 2,260 Joule per gram. One will notice that it takes 5 times the energy to provide the heat of vaporization per gram of water (at 100° C.) than what is needed to raise the temperature of one gram of water from 0 to 100° C. Therefore, the conversion of 10 liter of water released from the tubular bag of this present technology (from 100° C. water to 100° C. vapor) will absorb: 2,260×10,000 Joules of heat, or 22,600 KJ.

The specific heat of air is 1.01 J per gram per degree Celsius. The room has a volume of 133.3 cubit meters; the mass of air at standard temperature and pressure is 1,293 gram per cubit meter. Therefore, the mass of air in this room is 172,357 gram. Therefore, it will require the removal of 1.01×172,357, or 174,080 J (or 174 kJ) to lower the temperature of the air in the room by 1° C.

Since the vaporization of 10 liter of water will absorb 22,600 kJ, and all it takes to reduce the temperature of air in this room by 1° is 174 kJ, the temperature of the room will be reduced by 198.9° C. (if the room is completely isolated from all heat exchange with the outside environment). In reality this will not happen because in the absence of additional source of energy, as soon as the temperature of the room drops, there will not be enough energy to cause the evaporation of any water from the liquid state to the gaseous state; and much of the 10 liters of water will remain as liquid water.

Obviously, during a firestorm, the energy inside the room is affected by the heat outside the room. It is not possible to estimate how fast radiant heat penetrates the barriers (windows and walls); but the fact that vaporization of water will absorb a large amount of heat will explain why this present technology is effective in protecting the content of the house as well as the structure of the house.

The key is where the water is located when it starts to vaporize. The conventional method of spraying the lawns outside the house or the walls of the house will not be effective because the water will immediately run down by gravity and whatever thin film of water left on the wall will be blown away by the wind before the hot and dry air or the flame arrives at the house.

While detailed dimensions of the present technology will be given in the following section, it should be understood that they are but illustrations of the principles to be disclosed in this present technology. People skilled in the art will readily see that any number of variations can substitute what is described in the text. However, such variations still fall within the spirit and content of the present technology.

One major problem in trying to get water from a faucet or a showerhead inside the house is the lack of properly designed adaptors or connectors to use with these household faucets. The only way to get water is to put a bucket below the faucet to collect the water. The bucket filled with water is heavy to carry; much time is wasted (a) waiting for the bucket to fill; (b) running around from the faucet to the location where the water is need. This present technology provides the proper connector or adaptor connecting the source of water to where it can be used.

Another problem of using the bucket is that the water in the bucket must be used immediately, i.e. poured onto a fire regardless of whether too much water or too little water is available from the bucket. Outside the house, there are fixtures such as pipes with threads to allow attachment of a garden hose. However, the garden hose may not be available, or the threads do not match, and the hose kinks. Garden hoses are also seldom stored inside the house. It also requires the presence of a person to direct the water toward the flame. This present technology provides a means of storage of the water, which can be placed at a critical location where the heat is expected to be great. The means of storage will allow release of water either slowly (before the room is really hot, e.g. above human tolerance), or quickly (by the bag system bursting under the pressure from the heated water, or because the storage system is broken by hot debris from the approaching fire (e.g. embers).

A third problem of the prior art is the garden hose (if available) is outside the house and often not long enough to reach where it is needed. The present technology can use the means of storage as a conduit when the faucet is turned on, and it can be connected to as many similar devices as available, to use the combined device as a long and flexible hose, either in the presence of a person, or after the person has evacuated from the premise.

The following descriptions are more detail descriptions and illustrations of the present technology.

Referring to FIG. 1, the present technology can be comprised of three major components: the head unit 12, the body unit 30 and the tail unit 50.

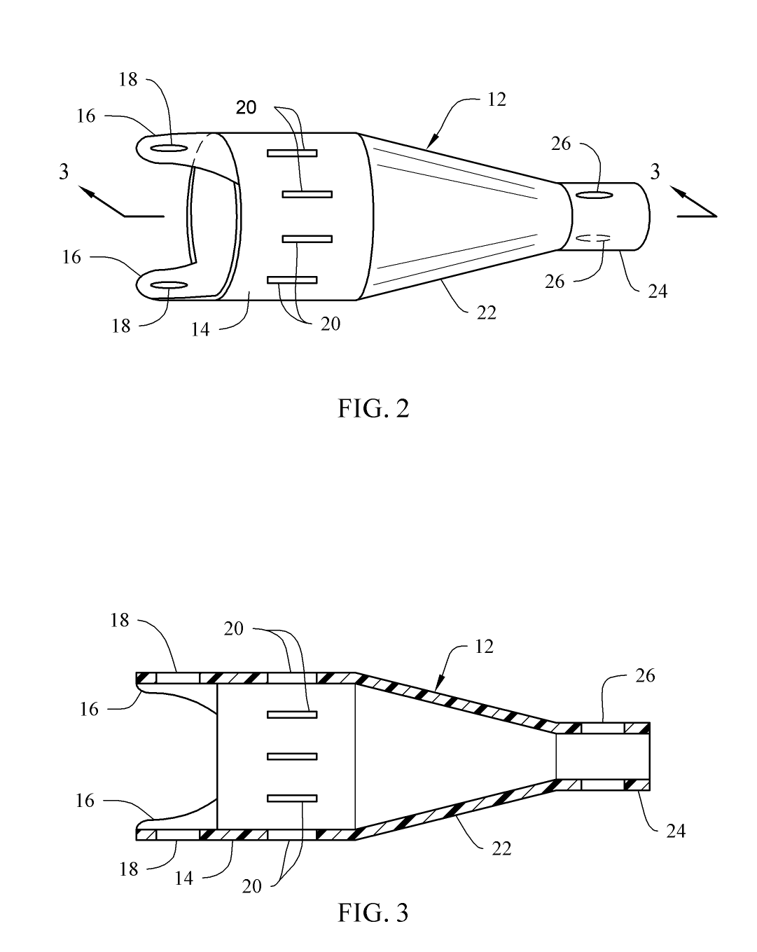

As best illustrated in FIGS. 2 and 3, the head unit 12 can be made of a flexible and elastic material, which is ideally flame-resistant so that it does not significantly deform at high temperatures. This may be important in case the outside fire is not severe, and the entire device can be re-used. However, at extreme high temperatures, the material may melt or be destroyed; even so, its purpose will have been accomplished because the water has been delivered safely and successfully from the water source to the storage component, which is the body unit 30 of the device. The head unit 12 can include a first end 14 including any number of flaps 16, which will allow the user to pull the head unit 12 onto the faucet until the external diameter of the faucet, can fit snugly with the internal surface of an intermediate funnel part 22 of the head unit 12. The external diameter of most household faucets ranges from 1 to 1.5 inches; therefore, the funnel part of the head unit 12 is 2 inches on the wide side and ¾ inches on the narrow end. The first end 14 of the head unit 12 also has optional slits 20 which would allow a piece of Velcro tape or strap (not shown) to wrap around this portion of the head unit 12 and be tightened by the Velcro so that when the water is running, the water will not easily pull the head unit 12 off the faucet. The flaps 16 can include holes 18 so that when the rigid structure 56 is inserted inside the head unit 12, protrusion 58 of the tail unit 50 can be inserted into the holes 18 to keep the tail unit 50 attached to the head unit 12

Located at the converge portion of the funnel part 22 is a second narrower end 24, which is about ¾ inch in internal diameter so that it can fit onto a rigid ring 32 with external diameter of ¾ inch. One or more holes 26 can be defined through the narrower end 24, which are configured or capable of allowing insertion of a protrusion or hook 34 from an end of the body unit 30 so that the two components are kept together if desired. Since the water source may come from a swimming pool, or from a shower, a variety of attachments will be used to deliver the water to the body unit 30.

The advantage of having more than one design of the head unit 12 is that while the water is filling into the body unit 30 using one design (e.g. for the faucet in the kitchen), the user can be free to set up a second set in the bathroom. The filling of the body unit with water from a faucet will typically take about one minute. Meanwhile, the user can use the head unit 12 suitable for connection to the showerhead, turn on the water from the showerhead and run back to the kitchen to stop the water there and start placing the water-filled to where it is needed in the kitchen or a near-by room. The typical volume of water that can be delivered by most household faucets or showers is about 5 to 10 liter per minute. Therefore little time is wasted from the user having to stand there waiting for one to fill and then pull it to where it is needed—every water source is filling some, when more than one device is available. The ideal time is to fill enough devices within 5 to 10 minutes and have them placed in strategic places, so that there is enough time for the user to leave the house safely.

FIG. 1 also shows the second component of the device, which is the body unit or tubular storage 30. The tubular design will have a flexible body of about 4 cm in diameter, and about 796 cm in length, for the purpose of holding at least 10 liters of water.

Table 2, below shows the various dimensions that can be used for the design of the body unit 30.

TABLE 2
Different designs of the of the Device

| | | Length | | | |
|---|---|---|---|---|---|
| | Cross - | required | | | Total area of |
| | sectional | to hold 10 | Length | Circum- | material need |
| Radius, | Area, | liters of | in | ference, | to build, |
| cm | sq. cm | water, cm | inches | cm | sq. cm |
| 2 | 12.6 | 796 | 313 | 12.6 | 10000 |
| 2.5 | 19.6 | 510 | 201 | 15.7 | 8000 |
| 3 | 28.3 | 354 | 139 | 18.8 | 6667 |

The body unit 30 can have a radius of 2 cm, because (1) a diameter of 4 cm is about 1.57 inches, which can be held easily in an adult hand; (2) it provides the length (313 inches, or 26 feet) that will allow the entire length of the body unit 30 to be lined up against the wall facing the approaching fire; we will use a room size of 20 feet, ×20 feet×10 feet high. The material needed to build this (total area) will be 10,000 sq. cm, but it is worth it because when used as a hose, it will be able to reach farther than the other designs with larger diameters for the body unit 30 but shorter length.

The body unit 30 has a rigid connecting part 32, which can allow the corresponding rubbery or stretchable part being the narrower end 24 of the head unit 12 to slide on; and has protrusions 34 to stick into the holding holes 26 on the head unit 12. A sliding-clamp or a closure-clamp 36 (Qosina, product 99943, 2.8 inches long) can be used to prevent water from leaking from the system, if desired at any time. The body unit 30 also has a holding mechanism; which will allow a C-clamp (not shown here) to hold the head unit 12 or the exposed ring 32 vertically upward to avoid spilling the water in the body unit, while allowing the water to evaporate. If the closure-clamp 36, 38 are both used to shut the open ends of the body unit 30, the rising temperature in the room will eventually reach a point where the pressure generated within the body unit 30 will cause the weakest part (wherever it may be) to break and allow the water (gaseous or liquid) to escape the system into the air in the room.

In terms of the folding of the long coil during storage or shipment, the entire device can be shipped in a spread-out fashion inside a box. The body unit 30 can have a diameter of 4 cm can have a circumference of 12.6 cm. This means when the tube is flatted, the width is 6.3 cm. The box is no shown here and is optional. It can serve as a container for the dry as well as for holding any spilt water after the body unit has been filled with water. The walls of the box can be high enough so that even if all the water leaks out of the body unit 30, the box will hold all the water. It will serve as an option for house owners who want a “clean carpet” (not wet by water) in case the fire never gets to the house. The box has another advantage: it can be used to drag the entire device easily to another room, even after the body unit has been filled with water. The entire assembly can be dragged outside for the water to be dumped in case the fire never gets to the house. The box can also become another reservoir for water, by removing the dry body unit from the box first and then placing the box at a location where it is most useful. One can then use the body unit 30 as a hose to fill water into the box at the location where water in the box will be useful to dampen the air. Then the body unit 30 will be used for its designed purpose of a flexible structure to fit into any space helpful to dampen the air or put out a fire.

FIG. 1 shows a “one-layer” arrangement of the tubular body unit 30. It is obvious that a second layer can be layered on top of the first so that the total surface area of the box can be much smaller (about half the size of the one-layer arrangement.) Alternatively, the flattened (empty) tubular body unit 30 can be folded in a pleated manner, just like how most real-life canvas fire hoses are folded inside their holding locations. Alternatively, the body unit 30 can be collapsed in an accordion-compression manner, which will expand when filled with water.

The body unit 30 can be made of material that can expand slightly with heat, but ideally will have weak point where the water can leak out along the entire length of the tubular structure. Any number of variations can be contemplated. For example, but limited to, by leaving the faucet on, and the head unit 12 attached to the faucet, a variety of devices can be attached to allow spread of the water into the air, to facilitate rapid evaporation of water droplets. Examples of such water-spraying devices would include “full pattern Shrub Sprinkler” and “half pattern Stream Bubbler” made by Orbit Irrigation Products, Utah.

At the other end of the body unit 30, there is another soft (elastic) connecting part 40 which can allow the corresponding rigid part or first end 52 of the tail unit 50 to slide inside; and the connection part 40 can include holes 42 to allow the protrusions 54 from the tail unit 50 to stick inside, to allow firm attachment to the tail unit 50. A sliding-clamp or a closure-clamp 38 (Qosina, product 99943, 2.8 inches long) can be used to prevent water from leaking from the system, if desired at any time. The body unit 30 can also has a holding mechanism 46 at this end; which will allow a C-clamp (not shown here) to hold the tail unit 50 or the exposed part of the connection part 40 vertically upward to avoid spilling the water from the body unit 30, while allowing the water to evaporate.

It is obvious that if one desires to have a tubular structure 30 twice the volume (2×10 liter) or a hose twice as long (2×313 inches), all one has to do is to link up one body unit 30 to another body unit 30 by attaching part 34 of the second body unit to the connection end 40 of the first body unit 30; and then part 40 of the second body unit to a tail unit 50.

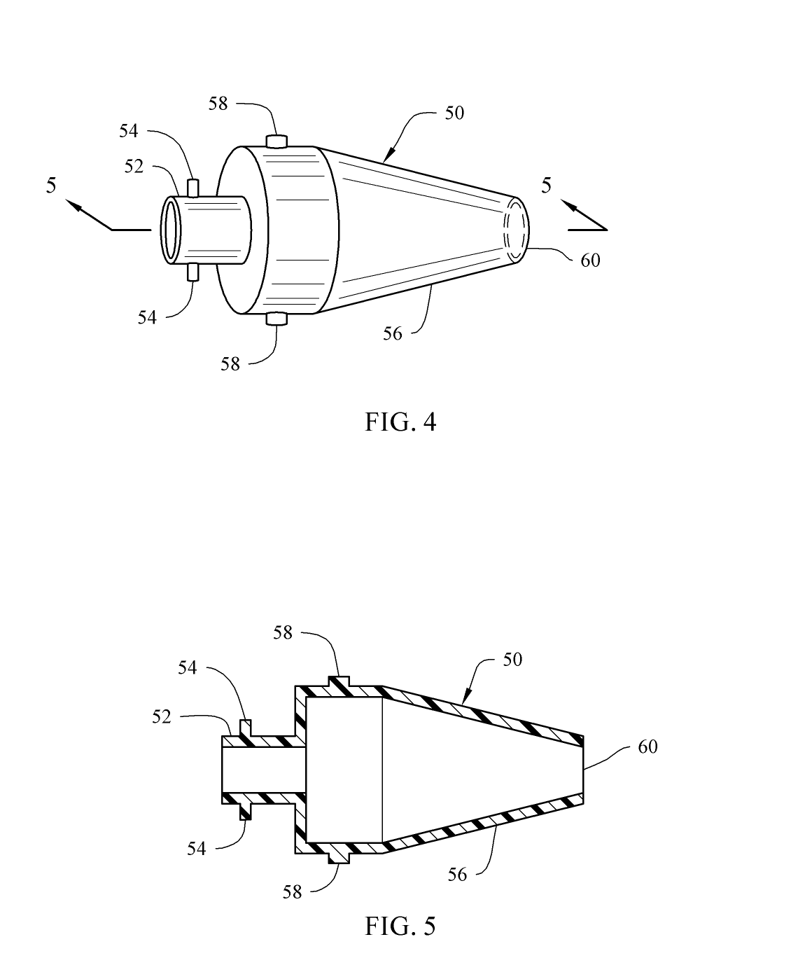

Referring to FIGS. 4 and 5, the tail unit 50 can be an “end-to-end hollow” structure, which allows attachment of the connecting soft part 40 of the body unit 30 to a rigid part or first end 52. Pins or protrusions 54 can be capable or configured to be inserted into hole(s) 42 to prevent detachment of the head unit 12 and tail unit 50. The tail unit 50 can include an intermediate funnel section 56 with an open converged end 60. The funnel section 56 can have a non-tapering section transitioning from the first end 52, and with a diameter larger than the first end 52. Pins or protrusions 58 can extend from the non-tapering section of the funnel section 56. After the attachment of the tail unit 50, there are several options available:

(a) The tail unit 50 can be turned upward, open to air (for water to escape on expansion, or to evaporate, depending on the situation as perceived by the user before he leaves the house).

(b) Attach the tail unit 50 inside the head unit 12 of the device, without sticking the protrusions 58 into the holding holes 18, so that the water is a single circular loop (provided the closure clamps are left open). When the water becomes hot, the pressure inside will easily separate the tail unit 50 from the head unit 12 and water will freely flow out.

(c) If the user does not want the water to leak out unless the temperature in the room is really hot, the user can stick the pins or protrusions 58 on the tail unit 50 into the holding holes 18 on the head unit 12, as best illustrated in FIG. 6. The result is a tight connection between the tail unit 50 and the head unit 12. These two will still separate if the water is really hot and much vapor is generated inside the body unit 30.

If the user decides to hang the tubular system high up inside the room or across a large window or glass door, the user can use the holding mechanism 44 and 46 of the body unit 30 and a C-clamp (not shown) to attach the body unit 30 in a manner most effective in his estimate to reduce the chance of a fire starting inside the room. Given the fact that hot air is lighter than cold air, exposing water to a higher location than ground level should be more effective and faster in causing the water to evaporate.

Referring to FIG. 7, an alternative attachment head unit 70 that can be fitted onto a showerhead. The alternate head unit 70 can include a first opened end 72 that can be about 3 inches in diameter so that the wider part 80 can wrap around a large showerhead with a diameter of about 4 inches. Many household showerheads are only 2 inches in diameter. When the head unit 70 is inserted into a 2-inch diameter shower-head, the wider part 80 of the funnel or conical portion 22 of the head unit 12 will accommodate this showerhead well because the head unit 12 has on its first end 14 a “width” of about 2 inches in diameter while the narrow part 24 is about ¾ inches in diameter.

The first end 72 can a plurality of slits 74, and at least of flap 76 extending therefrom, with the flap 76 defining a hole 78 configured to connect with the protrusion 58 of the tail unit 50. In addition, the slits 74 can correspond to the slits 20 of the head unit 12, for the insertion of a Velcro band or strap (not shown) to secure the head unit 12 onto the backside of the showerhead to prevent detachment. It can be readily seen that although there are multiple varieties of showerhead protectors (mainly used to prevent water dripping from the shower instead of delivering water to a tubular storage system) the design of the present technology is unique and non-obvious.

A funnel or conical section 82 extends from the wider part 80 in a converging manner, with a second end 84 extending from the converged end of the funnel section 82. The second end 84 can include one or more holes 86. The second end 84 and holes 86 of the alternative head unit 70 serve the same purpose and function as the holes 26 of the second end 24 of the head unit 12.

The following is a description of an embodiment of the present technology with particular reference to the head unit 12, 70.

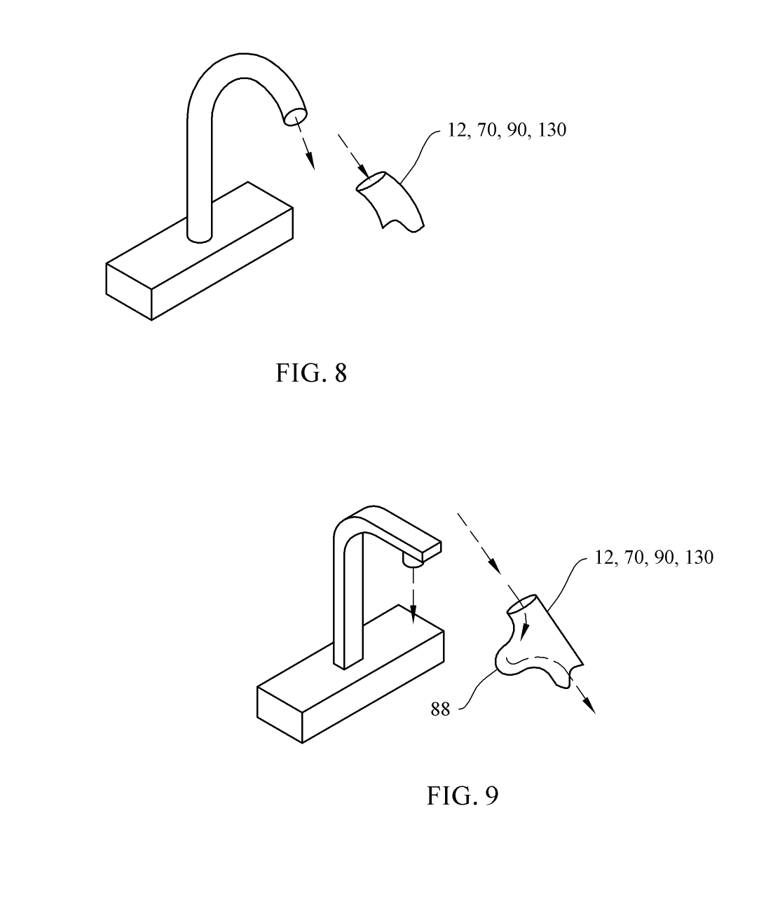

FIGS. 8 and 9 describe two major kinds of faucet designs found in American homes. Although there are hundreds of faucets sold in America with different appearances, they are essentially the (a) “Straight-out” design, or (b) “right-angle outward” design regarding the flow of water at the point where the water exits the faucet.

FIG. 8 describes the “Straight-out” design (with the open-shut controls of the faucet not presented in order to simply the discussion). The faucet has a swan-neck appearance where a straight tube is bent into a curve but essentially the water flows in a direction following the curve of the neck in a “straight-out” direction. If all the faucets are of this design, the attachment area of the head unit of the present technology can be a straight tube. The only requirement is that the diameter of the attachment area needs to be easily expandable to accommodate “swan necks” of different sizes. Therefore, we essentially want the head unit 12 of the present technology to be made of natural rubber, which can expand easily like a rubber band and recoil to attach tightly to the “swan neck.”

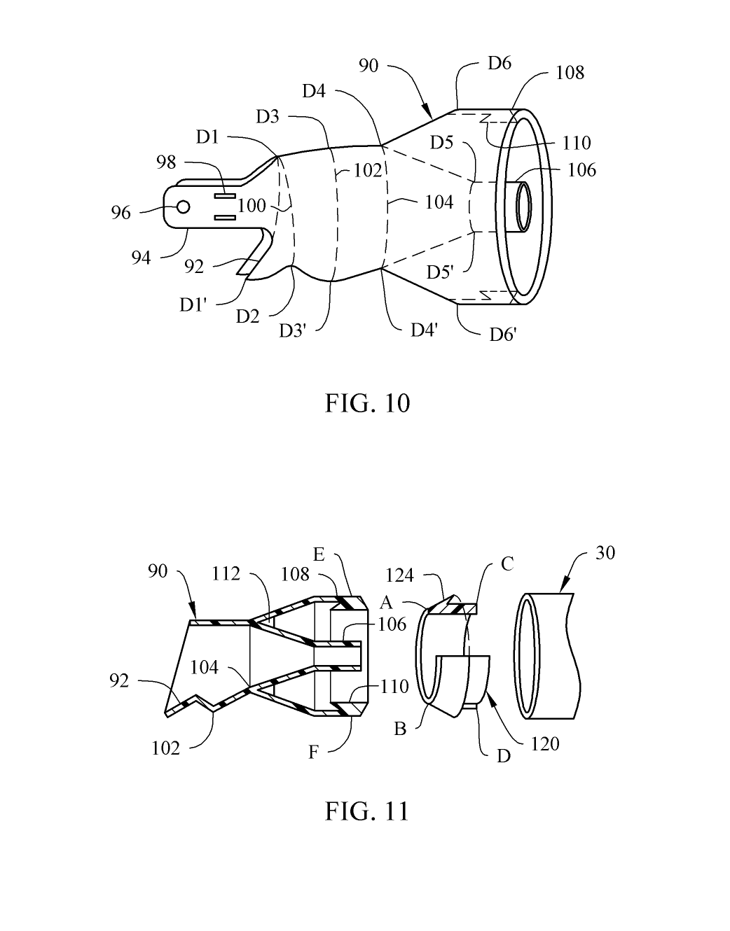

However, the other type of faucet design, as best illustrated in FIG. 9, where the water takes a 90 degree bend before it exits the faucet. Therefore, the attachment area of the head unit of the present technology can have a pouch 88 so that the water will not be obstructed in its outward flow by the “wall” at the attachment area. The idea is to allow rapid flow of water outwards from the faucet; the idea is not to seal off or retard the flow rate of water out of the faucet. The pouch 88 in FIG. 9 would correspond to area D3′, to be described later for FIG. 10.

Since the head unit of the present technology needs to be a “universal” attachment or connector with all kind of faucets designs with respect to the location where water comes out (which we will call the “tip” of the faucet), the preferred embodiment will allow easy attachment to both types of general designs for the tips of faucets, i.e. there will be sufficient internal surface inside the head unit o to hold onto “straight-out” tips as well as having a pouch which will allow water to come out of the “90 degree” design and then continue to flow into the body unit of the present technology.

Referring to FIG. 10, the present technology can include alternative head unit 90, refereed to herewithafter as dragon hose. The dragon hose 90 include a first end or mouth 92 including one or more flaps 94 configured to be positioned over a tip of a faucet. The mouth 92 can be defined by a pair of tabs extending away from the head unit 90 at an angle.

The flaps 94 define a button hole 96 which will secure the tail unit (not shown here, but it will have two corresponding “buttons”) when a tail or second end of another dragon hose is inserted for the sake of lengthening the total length of the combined dragon hose. There are also two slits 98 (⅛ inch wide, ×½ inch long) defined in the flaps 94 for the insertion of a fastening device, such as a Velcro fastener, or any flexible material, to tie the head unit 90 to any parts of the faucet, so that the head unit 90 will not slid off the faucet.

For exemplary purposes, the internal diameters of the different parts of the head unit 90 are described as follows:

| | | Diameter in |
|---|---|---|
| Description | Indicators in FIG. 10 | Inches |
| Mouth of the Dragon Hose | D1 to D1′ | 2.5 |
| Entrance to the Head | D1 to D2 | 2.0 |
| The Pouch | D3 to D3′ | 2.5 |
| The Pharynx | D4 to D4′ | 1.75 |
| The Esophagus | D5 to D5′ | ⅝ |
| The Neck | D6 to D6′ | 2.5 |

In some embodiments, the entrance section 100 has a diameter less than a diameter of the mouth 92, the pouch section 102 has a diameter greater than the entrance section 100, the pharynx 104 has a diameter less than the pouch section 102, and the esophagus section 106 has a diameter less than the pharynx 104.

The following is the rationale for the various diameters of the head unit 90 of the dragon hose:
a. The mouth 92 is wider than the entrance so that it can be inserted easier over any of the common sizes of faucet tips.
b. The entrance 100 becomes narrower so that the head unit 90 can hold tightly over the faucet tip after the faucet tip has entered into the head unit 90.
c. The pouch 102 is at least 2.5 inches in diameter so that water from “90 degree faucets” will be not obstructed by the “wall” created by the internal surface of the head unit 90 but can easily go through the space created by the pouch 102 onwards to the pharynx 104.
d. The pharynx 104 is narrower than the entrance so that narrower tips (from smaller faucets) can be inserted farther inside the head unit 90 and be gripped here by the pharynx 104.
e. The esophagus 106 is the narrowest pathway so that regardless of the external sizes of any faucet tips, there is enough contact surfaces inside the head unit 90 to hold onto the faucet tip. That is important because we do not expect the user to stay inside the building to make sure that the present technology will stay attached to the faucet, when a fire is approaching the building.
f. The neck 108 is where the head unit 90 can be joined to the body unit 30, through the utilization of a collar, which will be described below. The neck 108 can include a “catching” mechanism 110 to be described below, for the collar.

Overall, the passage into which the tip of the faucet will travel inside the head unit 90 of the dragon hose can taper, from 2.5 inches at the Mouth, to 0.625 inches at the esophagus 106, so that different kinds of faucet tips (with a wide range of diameters) can be held tightly by the internal surface of the head unit 90.

Referring to FIG. 11, a collar 120, which can be made of rigid material, preferably rigid plastic, is configured and capable of connecting the flexible, thin-bodied body unit 30 to the soft, elastic head unit 90 (ideally made of natural rubber). In a situation where the body unit 30 can be glued to the head unit 90, the collar 120 is not needed. But because rubber can age easily with time and the consumer may need to use the present technology many years after its purchase, we think that a collar 120 design will allow a more secure attachment between the and the head unit 90 than by using glue which can also be easily oxidized with age.

The collar 120 can be 0.75 inches long, with a diameter of 2.125 inches (from location C to D). On a first end 122 of the collar 120 is a circular wedge 124 that radially extends outward about 0.25 inches, where the widest diameter is about 2.5 inches (distance A to B) which will allow the body unit 30 to slide over easily. Part of the body unit 30 is depicted on the right side of FIG. 10. The body unit 30 is a flexible thin-plastic tube, about 2 mil thick. One example of such a plastic tube is poly tubing (model S-1114) to be purchased from U-Line. The catalog describes this model to have a “width” (when the tube is flat) of 4 inches. Using a formula of circumference equals to 2πR (R being radius), since the circumference is 4×2 inches, the diameter has to be 8 divided by π, which is 2.55 inches. In reality, the circumference of the product can be slightly larger than 8 inches. As such, the flexible tube can easily be slid over the widest diameter of the collar 120 (distance from A to B is only 2.5 inches) before the assembly is inserted into the rubber head unit 90 and be “caught” inside the neck 108 of the head unit 90.

The pouch 102 can be configured to accommodate faucets having enlarged areas, such as but not limited to, T-shaped faucets.

The collar 120 is illustrated in FIG. 11 as a cutaway for clarity. The thickness of the rubber can ⅛ inches (being the difference between distance E to F, minus the distance A to B), except at the end where it is about 5/16 inches thick (being the difference between the distance E to F, minus the distance C to D). The interior of the neck end 108 is shaped to accommodate the protruding wedge 124 of the collar 120. As such, when the collar 120 (with the end of the soft body unit 30 pulled over it, like a sleeve of a shirt over a hand) both the collar 120 and the body unit 30 would be caught firmly within the neck 108 and cannot easily be pulled out again. When water is turned on from the faucet, the water will flow out of the esophagus 106 and fill the body unit 30.

The connection 112 between the neck 108 and the pharynx 104 can be thickened, to reinforce the rubber material, so that the neck 108 cannot be easily ripped from the pharynx 104.

It can be appreciated that the wedge 124 of the collar 120 includes an angled surface created a latching surface that is engageable with a corresponding “catching” mechanism 110 of the neck 108 of the head unit 90.

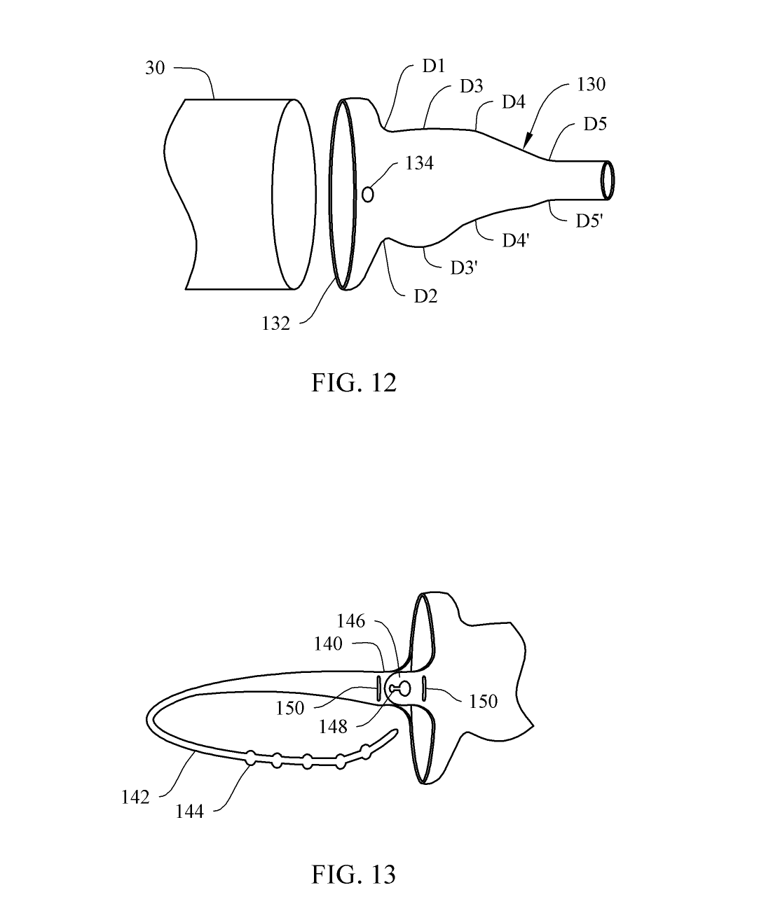

Referring to FIG. 12, an alternative tail unit 130 can be utilized with the present technology. Essentially the tail unit 130 can be made of hard plastic and will have an overall shape that conforms to the interior of the head unit. However, the external dimensions of the tail unit 130 can be slightly larger than the internal dimensions of the head unit, so that the rubber of the head unit will slightly expand and hold on tightly to the tail unit 130 when the tail unit 130 is inserted into the head unit. The purpose of this feature, that the tail unit 130 can be inserted into the head unit are at least two-fold:

(a) when one set is used, after water is seen running out of the tail unit 130, the user can detach the head unit from the faucet and insert the tail unit 130 into the head unit of the same set to form a circular body of water, without using any other device to stop water from leaking from the filled body unit. This can be useful, for example, in stopping a fire from starting in the fireplace. Often the embers from external fire will enter from the chimney and enter the house via the fireplace. If the user wants to place a “circular of water” beneath the chimney, it has the potential of allowing water to leak when a hot piece of ember enters the house via the chimney. Therefore, the water will moisturize the house only when a hot material enters the fireplace, but the fireplace will remain dry if no hot material enters, which will puncture the soft plastic skin of the body unit.

(b) If the user has two sets of the present technology, the user can double the length of the hose by inserting the tail unit of the first set (connected to the faucet) into the mouth of the second set of the present technology. Then the can spray water into a fire or smoke that is 50 feet away from the faucet.

Regarding the attachment of the rigid tail unit 130 to the body unit 30 (which is soft and pliable), the two components can be glued together. This step can be easier than gluing the body unit to the rubber head unit. The tail unit 130 can include two buttons 134 adjacent a first end 132, which are protruding bodies located at a location that will correspond to the button holes 26, 86 of the head unit when the tail unit 130 is suitably inserted inside the head unit. The insertion of the buttons 134 of the tail unit 130 into the button holes 26, 86 will prevent the easy detachment of the head unit from the tail unit 130, but it can easily be unbuttoned, if desired.

Referring to FIG. 13, the head units of the present technology can include alternate tabs or flaps extending from the first end of the head unit. The flaps can include a first flap 140, and a second flap 146. The first tab 140 can taper into a strand 142 featuring multiple sequentially spaced bumps 144. The bumps 144 have a diameter larger than the strand 142.

The second tab 146 includes a keyhole-like hole 148 that includes a first hole sized to receive the bumps 144 therethrough, a slot in communication with the first hole and sized to receive the strand 142 and not the bumps 144, and a second hole in communication with the slot and having a size larger than the slot and less than the first hole.

The strand 142 is configured for wrapping around a faucet so that the head unit will not disengaged from the faucet. The stand 142 can be made from a flexible material, such as but not limited to, a silicon or rubber material. The multiple bumps 144 provide an adjustability to accommodate different size faucets. A Slit 150 can be defined in each of the first tab and the second tab 146. The slit 150 of the second tab 146 should be located between the keyhole-like hole 148 and the first end of the head unit. The slits 150 would allow a piece of Velcro tape or strap (not shown) to wrap around this portion of the head unit and be tightened by the Velcro so that when the water is running, the water will not easily pull the head unit off the faucet

In conclusion, the present technology can be appreciated as a hose which can serve at least two purposes: (a) as a hose to spray water from a water source (such as a faucet) to a distance location; (b) as a means to hold a large body of water so that when the body is broken or punctured, water can leak or burst from the body to wet the surroundings, and to provide moisture to increase the humidity of the building so that the materials inside the building will not easily catch fire (even though the temperature will be very hot.) Once the outside fire has passed, there is less chance of the materials inside the building catching fire. The head unit, body unit and tail unit can be assembled as one piece, or to be sold as one piece, so that the user does not have to spend time putting them together in a crisis. The consumer will be advised to either leave the water running from the faucet, or have the body of water held inside the body unit (by using clamps, not shown here; or by sticking the tail unit inside the head unit.) The body unit filled with water can be placed near a location (e.g. beneath a window) where the outside fire is approaching (or under a chimney). The consumer will be advised to leave the building as soon as possible without attempting to hold on to the present technology to use it only as a hose. The idea is “Wet Wood Won't Burn”. The present technology does not claim to stop a house from burning. It only aims to provide water and/or moisture so that the wet or moisturized material inside the house will not catch fire as easily as would dry material.

While embodiments of the portable fire damage reducing system and method have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described. And although reducing the chance of a fire destroying a building have been described, it should be appreciated that the portable fire damage reducing system and method herein described is also suitable for dispensing and/or storing a liquid utilizing adaptable connections head and tail units.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed as being new and desired to be protected by Letters Patent of the United States is as follows:

1. A fluid system for storing or dispensing a fluid, said fluid system comprising:
a head unit including a head first end connectable to a fluid source;
a body unit including a body first end connectable to a head second end of said head unit, and a body second end, said body unit configured to store fluid or to deliver fluid; and
a tail unit including a tail first end connectable to said body second end, and a tail second end having a configuration capable of being open to the atmosphere for dispensing the fluid from said body unit or connected to said head first end of said head unit to form a closed looped system with the fluid stored in said body unit.

2. The fluid system of claim 1, wherein said head unit including a head intermediate section having a conical configuration converging from said head first end toward said head second end.

3. The fluid system of claim 2, wherein said head first end including one or more flaps extending therefrom, one or more flap holes defined through said flaps, and multiple radially arranged slits defined through said head first end.

4. The fluid system of claim 3, wherein said head second end including one or more holes defined therethrough, said holes each being configured to engageably receive a protrusion extending from said body first end of said body unit.

5. The fluid system of claim 3, wherein said tail unit including a tail intermediate section having a conical configuration converging from said tail first end toward said tail second end.

6. The fluid system of claim 5, wherein said tail first end of said tail unit including one or more protrusions extending therefrom, and wherein said body second end of said body unit defines one or more holes each configured to engageably receive at least one of said protrusions extending from said tail first end.

7. The fluid system of claim 5, wherein said tail unit including one or more second protrusions extending from said tail intermediate section, each of said second protrusions being configured to be engageably receive in one of said flap holes.

8. The fluid system of claim 3, wherein said head unit includes a bulged section between said head first end and said head intermediate section, said bulged section having a diameter larger than said head first end and said head intermediate section.

9. The fluid system of claim 1, wherein said body unit includes a conduit extending between said body first end and said body second end.

10. The fluid system of claim 1, wherein said head unit includes a mouth associated with said head first end, an entrance section adjacent said mouth, a pouch section adjacent said entrance section, a pharynx adjacent said pouch section, and an esophagus section adjacent section adjacent said pharynx and associated with said head second end.

11. The fluid system of claim 10, wherein said head unit includes a neck section extending from said pharynx and exteriorly concentric with said esophagus section.

12. The fluid system of claim 11 further comprises a collar having a collar first end featuring a wedge extending outwardly and away from said collar first end, said wedge including a catch surface, and wherein said neck section includes a catch surface extending interiorly therefrom and configured to engage with said catch surface of said wedge when said collar first end is received into said neck section of said head unit.

13. The fluid system of claim 12, wherein said collar includes a collar second end connectable to said body first end of said body unit.

14. The fluid system of claim 11, wherein said entrance section has a diameter less than a diameter of said mouth, said pouch section has a diameter greater than said entrance section, said pharynx has a diameter less than said pouch section, and said esophagus section has a diameter less than said pharynx.

15. The fluid system of claim 1, wherein said head unit is configured to be attachable to a faucet so that a fluid output of the faucet is received in said head first end.

16. The fluid system of claim 1, wherein said head unit includes a strand extending from said head first end, said strand including multiple enlarged sections each being configured to be engageable with a hole defined in said head unit.

17. A method of using the system of claim 1, said method comprising the steps of:
a) connecting said head first end to the fluid source;
b) receiving fluid in said body unit from said head unit;
c) utilizing said tail unit to dispense the fluid from said body unit or store the fluid in said body unit by connecting said tail second end of said tail unit into said head first end of said head unit when said head first end is disconnected from the fluid source.
